(19) United States
(12) Patent Application Publication
(10) Pub. No.: US 2025/0141783 A1
(43) Pub. Date: May 1, 2025

(54) SYSTEM, METHOD AND PROGRAM FOR COLLECTING DATA

(71) Applicant: NIPPON TELEGRAPH AND TELEPHONE CORPORATION, Tokyo (JP)

(72) Inventors: Ryohei TSUGAMI, Musashino-shi, Tokyo (JP); Tatsuya FUKUI, Musashino-shi, Tokyo (JP)

(73) Assignee: NIPPON TELEGRAPH AND TELEPHONE CORPORATION, Tokyo (JP)

(21) Appl. No.: 18/837,877

(22) PCT Filed: Feb. 25, 2022
(86) PCT No.: PCT/JP2022/007856

§ 371 Date: Aug. 12, 2024

(51) Int. Cl. H04L 45/24; H04L 67/1097

(52) U.S. Cl. CPC H04L 45/24; H04L 67/1097

(57) ABSTRACT

An object of the present disclosure is to provide a system that does not require a large amount of network resources even in a case of collecting data from a large number of data sources.

The present disclosure is a system for collecting data from a plurality of data sources to a server, the system including: a controller that determines a transmission policy to be distributed to the plurality of data sources, in which the controller determines the transmission policy for each data source on a basis of a data transfer requirement from the plurality of data sources to the server, calculates a total resource use amount of a case where the plurality of data sources executes the transmission policies set for the respective data sources, and adjusts the transmission policy for each data source so that the total resource use amount falls within a set threshold.

### TECHNICAL FIELD

The present disclosure relates to communication control for data collection.

### BACKGROUND ART

User terminals, sensors, and in-vehicle systems have been developed, and the number of sensors and the data amount generated from each sensor have been greatly increased. When the data is collected in a conventional communication method, there is a possibility that processing of communication on a reception side may become a bottleneck.

As a high-speed data transfer method, remote direct memory access (RDMA) has been studied. In RDMA, data is transferred by DMA (data is directly transferred between, for example, a peripheral device and a main memory (RAM) without passing through a CPU) from a memory of a local computer to a memory of a different remote computer. For this reason, RDMA does not require CPU processing for data transfer, and thus can avoid the bottleneck on the reception side.

A remote transfer technique using this RDMA has been proposed (see, for example, Non Patent Literature 1). However, in Non Patent Literature 1, it is necessary to set a communication path for each flow in advance in order to transfer data by RDMA in a wide area communication network. Therefore, in a case of collecting data from a large number of data sources, a large amount of network resources is required.

### CITATION LIST

### Non Patent Literature

Non Patent Literature 1: “Hitori 1-hacho” de 100 Gbps datsu TCP/IP de cho-teichien (100 Gbps by “1 person 1 wavelength”, ultra-low delay by de-TCP/IP), Nikkei Electronics, 2021-03, P40-47

### SUMMARY OF INVENTION

### Technical Problem

An object of the present disclosure is to provide a system that does not require a large amount of network resources even in a case of collecting data from a large number of data sources.

### Solution to Problem

A system and a method according to the present disclosure include:
in the system for collecting data from a plurality of data sources to a server,
a controller that determines a transmission policy to be distributed to the plurality of data sources, in which
the controller
determines the transmission policy of each data source on the basis of a data transfer requirement from the plurality of data sources to the server,
calculates a total resource use amount of a case where the plurality of data sources executes the transmission policies set for the respective data sources, and
adjusts the transmission policy for each data source so that the total resource use amount falls within a set threshold.

Each of the devices such as the controller and the data sources of the present disclosure can also be implemented by a computer and a program, and the program can be recorded in a recording medium or provided through a communication network. A program of the present disclosure is a program for causing a computer to be implemented as each functional unit included in the devices according to the present disclosure, and is a program for causing a computer to execute each step included in a method to be executed by the devices according to the present disclosure.

### Advantageous Effects of Invention

According to the present disclosure, it is possible to provide a system that does not require a large amount of network resources even in a case of collecting data from a large number of data sources.

### BRIEF DESCRIPTION OF DRAWINGS

FIG. 1 illustrates a system configuration example of the present disclosure.

FIG. 2 illustrates a configuration example of a communication network.

FIG. 3 illustrates a configuration example of a server.

FIG. 4 illustrates a configuration example of a data source.

FIG. 5 illustrates an example of information stored in a requirement table of each data source.

FIG. 6 illustrates a configuration example of a transmission control controller.

FIG. 7 is an example of a transmission policy determination sequence according to the present disclosure.

FIG. 8 illustrates an example of an operation in a transmission policy determination function.

FIG. 9 illustrates an example of information stored in a transmission policy table.

FIG. 10 illustrates an example of an operation in a transmission policy determination function 22.

FIG. 11 illustrates an example of information stored in the transmission policy table after adjustment.

FIG. 12 illustrates a configuration example of a path management controller.

FIG. 13 illustrates an example of a path setting location table.

FIG. 14 illustrates an example of transmission of sensing data from a data source B to a server.

FIG. 15 illustrates an example of transmission of sensing data from a data source A to the server.

FIG. 16 illustrates an example of transmission of sensing data from a data source C to the server.

FIG. 17 illustrates an example of an Attribute ID region.

FIG. 18 illustrates an example of a sequence at the time of generating and releasing a communication path.

FIG. 19 illustrates an example of a sequence at the time of generating and releasing a communication path.

### DESCRIPTION OF EMBODIMENTS

Hereinafter, embodiments of the present disclosure will be described in detail with reference to the drawings. The present disclosure is not limited to the embodiments to be described below. These embodiments are merely examples, and the present disclosure can be implemented in a form with various modifications and improvements based on the knowledge of those skilled in the art. Note that components having the same reference numerals in the present specification and the drawings indicate the same components.

### First Embodiment

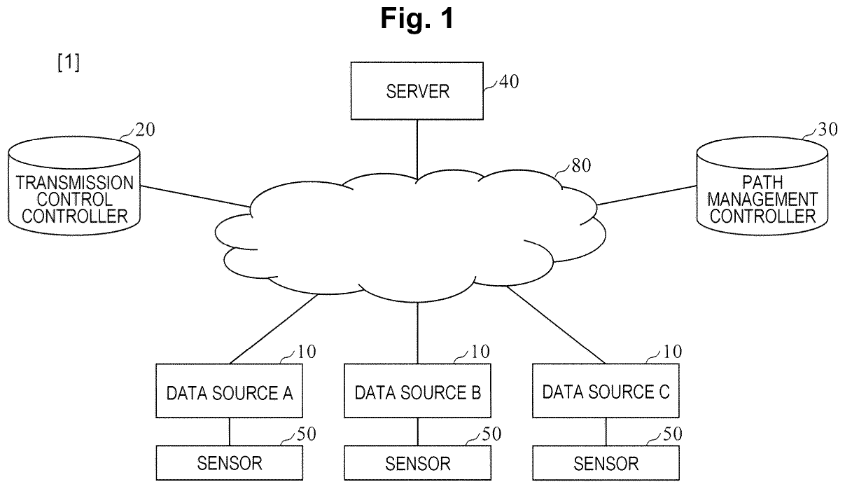

FIG. 1 illustrates a system configuration example of the present disclosure. A system of the present disclosure includes a plurality of data sources 10, a transmission control controller 20, a path management controller 30, and a server 40. The plurality of data sources 10, the transmission control controller 20, the path management controller 30, and the server 40 are connected by a communication network 80. Each of the data sources 10 is a terminal having sensing data on a user side. The server 40 is a terminal that collects data from the data sources 10.

In the present embodiment, an example in which the transmission control controller 20 and the path management controller 30 are separately arranged is illustrated, but these controllers may be provided in a common device or may be configured by a plurality of devices arranged in a distributed manner. The device of the present disclosure can also be implemented by a computer and a program, and the program can be recorded in a recording medium or provided through a communication network.

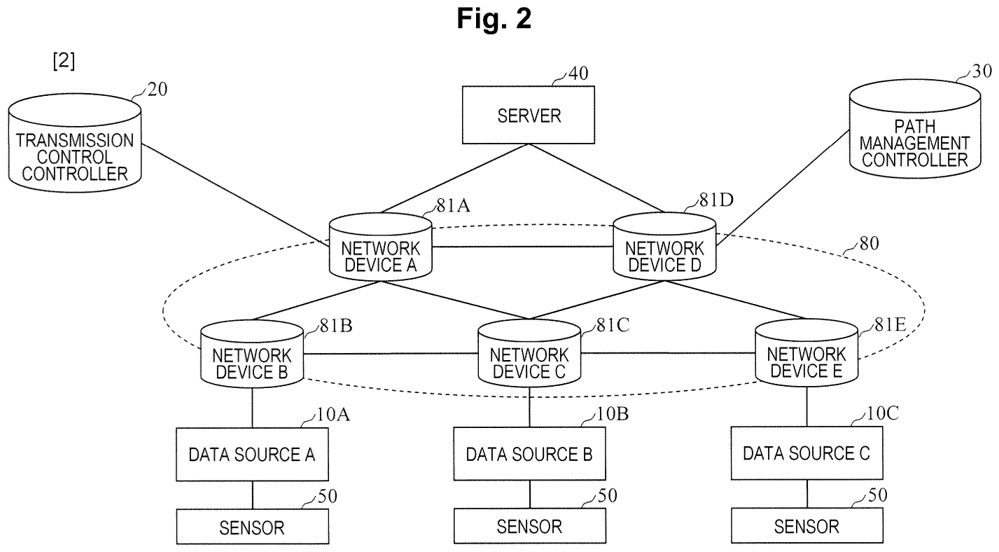

FIG. 2 illustrates a configuration example of the communication network 80. The communication network 80 includes a plurality of network devices 81. In the present embodiment, the network devices 81 used between the data sources 10 and the server 40 are determined in advance. For example, a data source 10A and the server 40 are connected by network devices 81A and 81B, a data source 10B and the server 40 are connected by network devices 81A and 81C, and a data source 10C and the server 40 are connected by network devices 81D and 81E.

Each of the network devices 81A to 81E knows to which network device data should be transferred when the data addressed to the server 40 is received from the data sources 10A to 10C. Therefore, even if it is unknown which of the network devices 81 is to be used, the data sources 10A to 10C specify the server 40 and transmit data, whereby the data is transmitted to the server 40. Accordingly, the present disclosure can transfer data in a lossless and broadband manner when a communication path is generated.

The present disclosure proposes a method of allocating a lossless and broadband communication path to the necessary data source 10 at necessary timing in order to implement data transfer by RDMA. In the system of the present disclosure, when data to be transmitted to the server 40 is generated, each of the plurality of data sources 10 generates a communication path using the network device 81 set in the local device at transmission timing set in a transmission policy of the local device. As a result, each data source 10 can autonomously transmit the sensing data to the server 40 on the basis of the transmission policy of the local device.

The transmission policy includes the following examples.

First transmission policy: A communication path is generated and data transfer is performed immediately after data generation, and the communication path is released immediately after data transfer completion.

Second transmission policy: A communication path is generated and data transfer is performed after a certain amount of data is accumulated, and the communication path is released immediately after data transfer completion.

Third transmission policy: A communication path is generated and data transfer is performed immediately after data generation, and the communication path is continuously held for a certain period of time after data transfer completion.

Fourth transmission policy: A communication path is generated and data transfer is performed after a certain amount of data is accumulated, and the communication path is continuously held for a certain period of time after data transfer completion.

In the present embodiment, with the provision of the transmission control controller 20, the transmission policy that matches a data transfer requirement of the data source 10 is distributed. Then, each data source 10 notifies the path management controller 30 of a connection request or a release request of the communication path according to the transmission policy in consideration of a sensor characteristic and the data transfer requirement for each application, and performs timing control of generation or release of the communication path. As a result, the present embodiment controls trade-off between immediacy of data transmission and reduction in communication path use time.

Here, there is a possibility that a resource demand of the entire network increases if all the data sources 10A to 10C try to transmit data in their best ways. Therefore, in the present disclosure, the transmission control controller 20 determines the transmission policy in consideration of the entire network resources. Details will be described below.

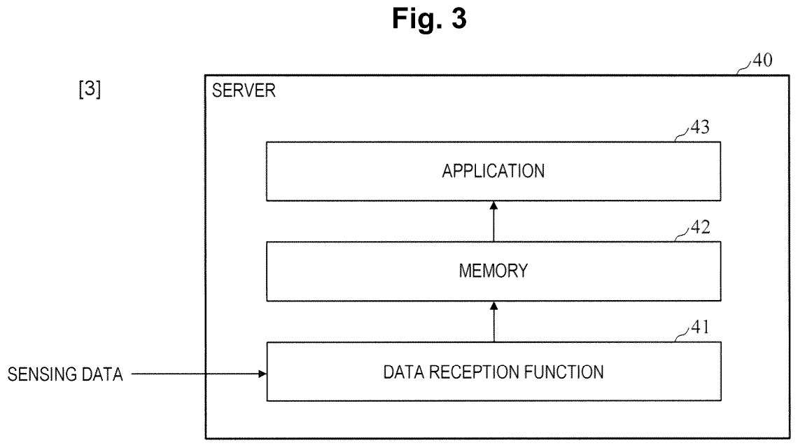

FIG. 3 illustrates a configuration example of the server 40. The server 40 includes a data reception function 41, a memory 42, and an application 43.

The data reception function 41 receives sensing data from each data source 10.

The memory 42 stores sensing data from a sensor 50.

The application 43 collects the sensing data from the sensor 50. The application 43 is any application that collects any sensing data detected or generated by a user terminal, a sensor, an in-vehicle system, or the like.

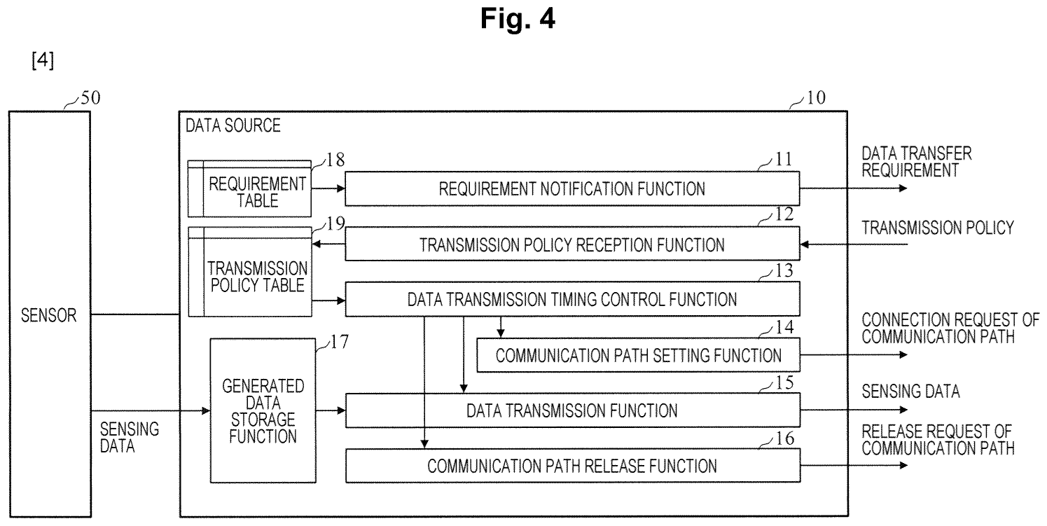

FIG. 4 illustrates a configuration example of the data source 10. The data source 10 includes a requirement notification function 11, a transmission policy reception function 12, a data transmission timing control function 13, a communication path setting function 14, a data transmission function 15, a communication path release function 16, a generated data storage function 17, a requirement table 18, and a transmission policy table 19.

The generated data storage function 17 stores the sensing data from the sensor 50.

The requirement notification function 11 reads the data transfer requirement from the requirement table 18 and notifies the transmission control controller 20 of the read data transfer requirement.

The transmission policy reception function 12 receives the transmission policy from the transmission control controller 20.

The data transmission timing control function 13 controls the communication path setting function 14, the data transmission function 15, and the communication path release function 16 in accordance with the transmission policy table 19.

The communication path setting function 14 transmits the connection request of the communication path to the path management controller 30.

The data transmission function 15 transmits the sensing data stored in the generated data storage function 17 to the server 40.

The communication path release function 16 transmits the release request of the communication path to the path management controller 30.

The requirement table 18 stores the data transfer requirement for each data source 10.

The transmission policy table 19 stores a policy of when the sensing data is transmitted from the data source 10 to the server 40.

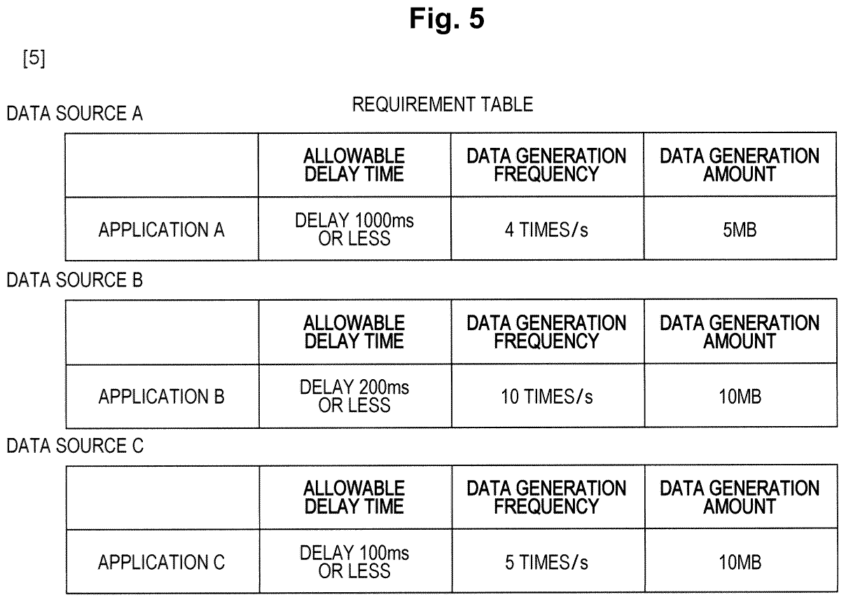

FIG. 5 illustrates an example of information stored in the requirement table 18 of each data source. Each requirement table stores, as the data transfer requirement, an allowable delay time, a data generation frequency, and a data generation amount of each data source 10 in association with the application. The allowable delay time is an allowable delay time from generation to arrival of data at the server. The data generation amount is a data amount generated at a time in the sensor 50. The data generation frequency and the data generation amount in the sensor 50 are not limited to be constant. In this case, an average data generation frequency and an average data generation amount, which are average values for each sensor 50, can be used.

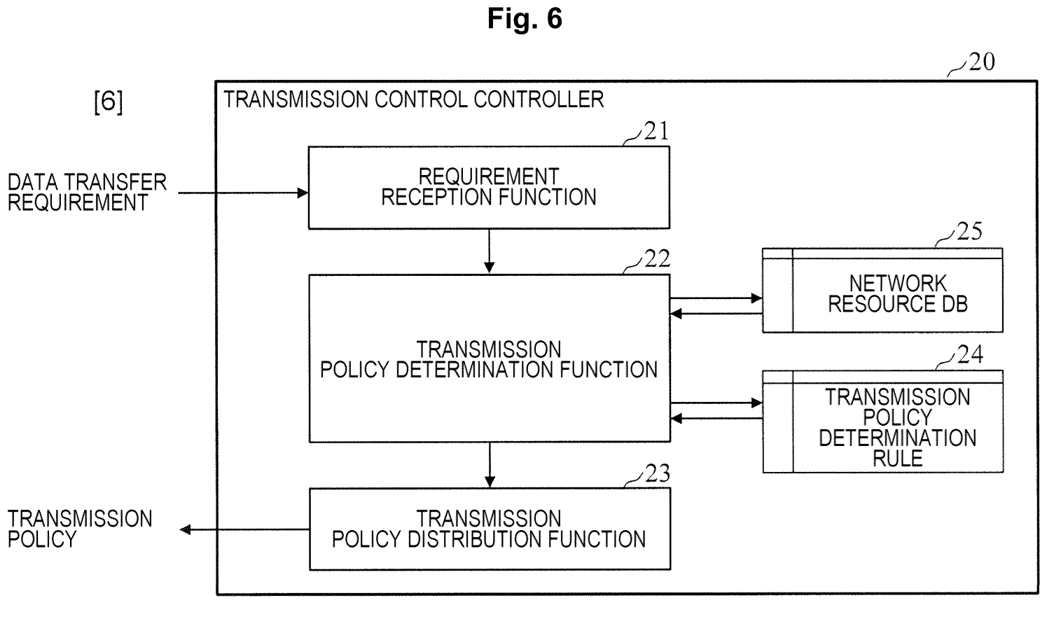

FIG. 6 illustrates a configuration example of the transmission control controller 20. The transmission control controller 20 includes a requirement reception function 21, a transmission policy determination function 22, a transmission policy distribution function 23, a transmission policy determination rule 24, and a network resource DB 25.

The network resource DB 25 stores the configuration of the communication network 80 illustrated in FIG. 2 and information of resources of each communication path in the communication network 80. The network resource DB 25 does not need to be provided in the transmission control controller 20, and may be stored in any device accessible from the transmission control controller 20 via a network.

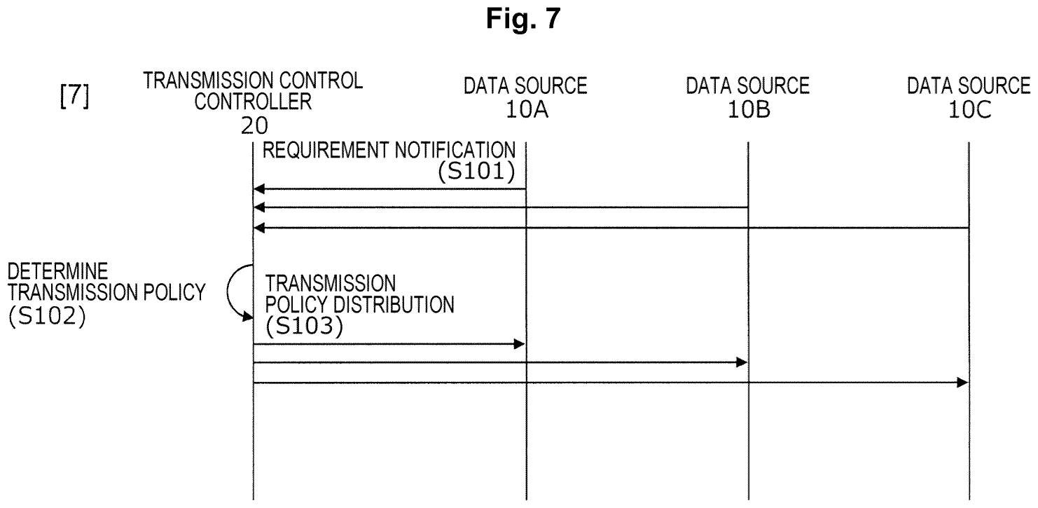

FIG. 7 illustrates an example of an operation in the transmission control controller 20.

Each data source 10 notifies the transmission control controller 20 of the data transfer requirement on the basis of the information of the requirement table 18 (S101). The data transfer requirement includes the allowable delay time and the data generation frequency of each data source 10 as illustrated in FIG. 5.

The requirement reception function 21 of the transmission control controller 20 receives the data transfer requirement from the data source 10. The transmission policy determination function 22 determines the transmission policy for each data source 10 according to the data transfer requirement in accordance with the transmission policy determination rule 24 (S102).

The transmission policy distribution function 23 of the transmission control controller 20 distributes the determined transmission policy to each data source 10 (S103).

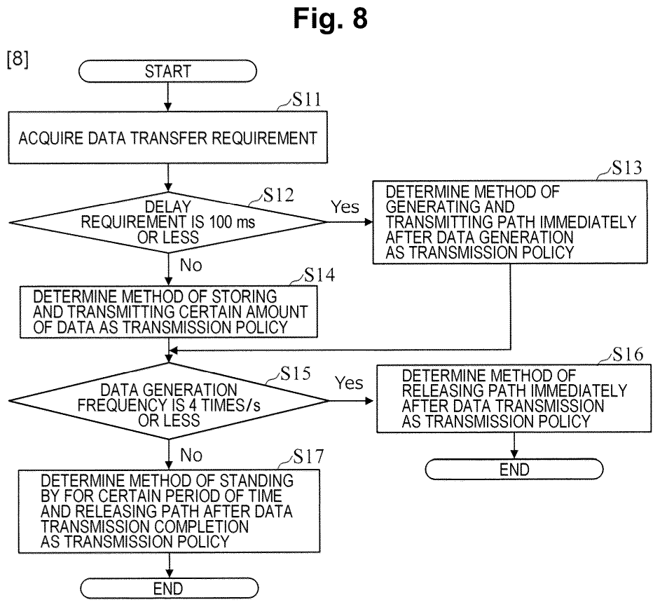

FIG. 8 illustrates an example of an operation in the transmission policy determination function 22.

When acquiring data transfer requirement from one of the data source 10 (S11), the transmission control controller 20 determines a requirement for the allowable delay time (S12). In a case where the requirement for the allowable delay time is 100 ms or less (Yes in S12), a method of generating the communication path and transmitting the communication path immediately after data generation is determined (S13). On the other hand, in a case where the requirement for the allowable delay time exceeds 100 ms (No in S12), a method of storing a certain amount of sensing data and transmitting the sensing data is determined (S14).

Next, the transmission control controller 20 determines the data generation frequency (S15). In a case where the data generation frequency is 4 times/s or less (Yes in S15), a method of releasing the communication path immediately after data transmission is determined (S16). On the other hand, in a case where the data generation frequency exceeds 4 times/s (No in S15), a method of standing by for a certain period of time and releasing the communication path after data transmission completion is determined (S17).

For example, in the case of the data transfer requirement illustrated in FIG. 5, the transmission policy determination function 22 makes a determination as follows:

### Data Source A:

Since a set time of the allowable delay time is 1000 ms, and a set value of the data generation frequency is 4 times, the transmission control controller 20 determines the second transmission policy as the transmission policy.

### Data Source B:

Since a set time of the allowable delay time is 200 ms, and a set value of the data generation frequency is 10 times, the transmission control controller 20 determines the fourth transmission policy as the transmission policy.

### Data Source C:

Since a set time of the allowable delay time is 100 ms, and a set value of the data generation frequency is 5 times, the transmission control controller 20 determines the third transmission policy as the transmission policy.

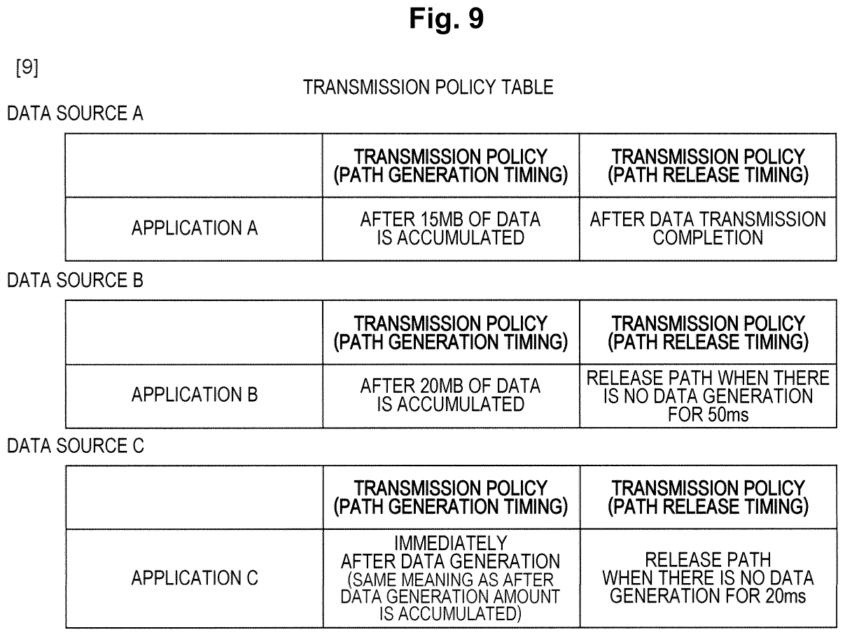

As a result, the transmission policies as illustrated in FIG. 9 are provided to the data sources A to C.

Here, the data transfer requirement may include application information. In this case, the transmission control controller 20 sets a threshold in consideration of the requirements included in the application information in steps S12 and S15.

When the transmission policy is determined, a resource use amount of a case where each of the data sources A to C executes the transmission policy can be calculated. Although a method of calculating the resource use amount is arbitrary, for example, the following equations can be used.

The resource use amount=(a path generation overhead+a transfer time+a path release standby time)*a path generation frequency

The transfer time=a transfer data amount/a communication band

The path generation frequency=the data generation frequency*the data generation amount/an accumulation amount Here, the path generation overhead is a head portion indicating the connection request of a communication path, and may be any value. In the present embodiment, an example of 0.03 s is given as an example. The path release standby time corresponds to path release timing in the transmission policy.

### Data Source A

It is the transmission policy in which the data generation frequency is 4 times/s, the data generation amount is 5 MB/time, and the communication path is generated after 15 MB is accumulated.

The path generation frequency: 1.3 times/s=(5 [MB/time]×4 [times/s])/15 [MB]

The transfer time: 0.012 s=15 [MB]/(10 [Gb/s]/8)

The resource use amount: 0.056=(0.03+0.012+0)*1.3

### Data Source B

It is the transmission policy in which the data generation frequency is 10 times/s, the data generation amount is 10 MB/time, the communication path is generated after 20 MB is accumulated, and release of the communication path is waited for 0.05 s.

The path generation frequency: 5 times/s=(10 [MB/time]×10 [times/s])/20 [MB]

The transfer time: 0.016 s=20 [MB]/(10 [Gb/s]/8)

The resource use amount: 0.48=(0.03+0.016+0.05)*5

### Data Source C

It is the transmission policy in which the data generation frequency is 5 times/s, the data generation amount is 10 MB/time, the communication path is immediately generated, and release of the communication path is waited for 0.02 s.

The path generation frequency: 5 times/s

The transfer time: 0.008 s=10 [MB]/(10 [Gb/s]/8)

The resource use amount: 0.29=(0.03+0.008+0.02)*5

In a case where the resource use amounts of the respective data sources are 0.056, 0.48, and 0.29, a total resource use amount of a case where the data sources A, B, and C execute the transmission policies is 0.826.

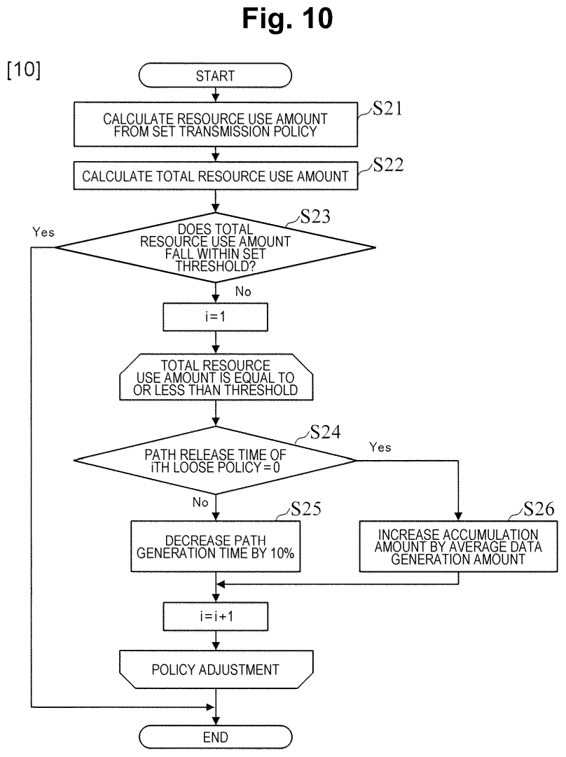

The transmission policy determination function 22 adjusts the transmission policy with reference to the network resource DB 25. FIG. 10 illustrates an example of an operation in the transmission policy determination function 22.

The resource use amount is calculated using the set transmission policy (S21).

Next, the network resources are read from the network resource DB 25, and the total resource use amount is calculated (S22).

Next, whether the total resource use amount falls within a set threshold is determined (S23).

In a case where the total resource use amount falls within the set threshold (Yes in S23), the determination of the set transmission policy is terminated.

On the other hand, in a case where the total resource use amount does not fall within the set threshold (No in S23), the transmission policy of each data source is adjusted such that the total resource use amount becomes equal to or less than the set threshold. Specifically, in order of looseness of the transmission policy (S24), path release timing is advanced (S25), or path generation timing is delayed by increasing the accumulation amount at the path generation timing (S26). This can reduce a time in which the data source 10 with a loose transmission policy consumes network resources, and reduce the total resource use amount.

According to the requirement table of FIG. 5, the allowable delay time (1000 ms) of the data source A>the allowable delay time (200 ms) of the data source B>the allowable delay time (100 ms) of the data source C is satisfied. In this case, in step S24, the transmission policy is adjusted in the order of the data sources A, B, and C. In a case of Yes in step S23 only by the adjustment of the transmission policy of the data source A, the processing is terminated, or in a case where the transmission policy of the data source B also needs to be adjusted, the transmission policy of the data source B is also adjusted. In this manner, the present disclosure adjusts the transmission policy in descending order of the allowable delay time.

A case where the set threshold is 0.8, and the adjustment is performed by reducing the path release standby time of the transmission policy by 10% in step S25, and increasing the data accumulation amount by one time of data generation amount in step S26 will be described in detail.

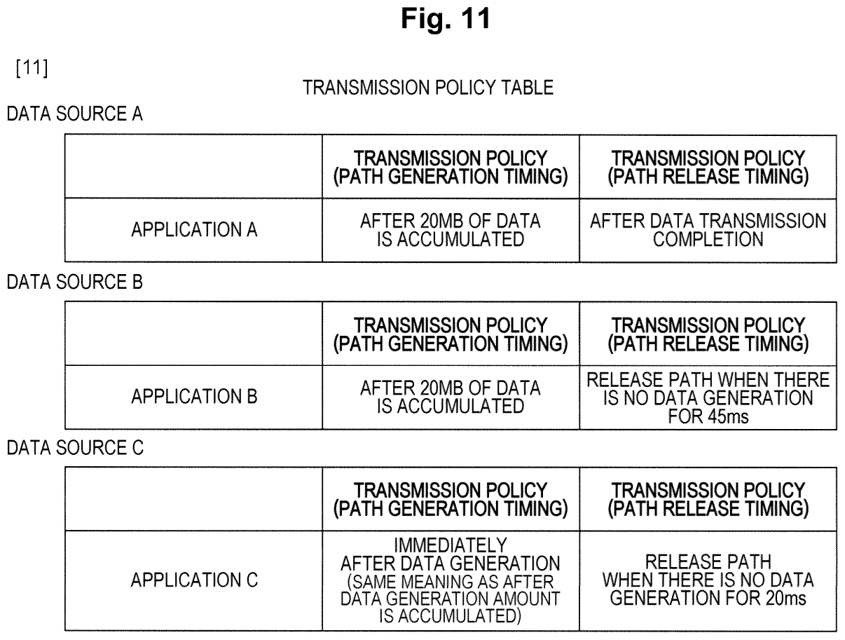

Since the path release timing of the data source A is after data transmission completion and the path release standby time is 0 (Yes in S24), step S26 is executed. In step S26, the data accumulation amount is increased by 5 MB corresponding to one time of data generation amount. As a result, as illustrated in FIG. 11, the transmission policy is adjusted such that data is transmitted after 20 MB of data is accumulated.

The transmission policy of the data source A is the transmission policy of generating the communication path after 20 MB is accumulated. The resource use amount of the data source A at this time can be calculated as follows.

The path generation frequency: 1.0 times/s=(5 [MB/time]×4 [times/s])/20 [MB]

The transfer time: 0.016 s=20 [MB]/(10 [Gb/s]/8)

The resource use amount: 0.046=(0.03+0.016+0)*1.0

The transmission policy determination function 22 calculates the total resource use amount of the case where the data sources A, B, and C execute the transmission policies on the basis of the transmission policy of the data source A after adjustment, and compares the total resource use amount with a threshold. For example, since the resource use amount of the data source A after adjustment is 0.046, the total resource use amount of the case where the data sources A, B, and C execute the transmission policies is 0.816. Since the set threshold is 0.8, the transmission policy of the data source B with the next longest allowable delay time is adjusted.

Since the path release timing of the data source B is release when there is no data generation for 50 ms, step S25 is executed. In step S25, the path generation time is shortened by 5 ms, which is 10% of 50 ms. As a result, as illustrated in FIG. 11, the transmission policy is adjusted so as to release the path when there is no data generation for 45 ms.

The transmission policy of the data source B is the transmission policy of releasing the path when there is no data generation for 45 ms. The resource use amount of the data source B at this time is 0.455=(0.03+0.016+0.455)*5.

The transmission policy determination function 22 calculates the total resource use amount of the case where the data sources A, B, and C execute the transmission policies on the basis of the transmission policy of the data source B after adjustment, and compares the total resource use amount with a threshold. For example, since the resource use amount of the data source B after adjustment is 0.455, the total resource use amount of the case where the data sources A, B, and C execute the transmission policies is 0.719. Since the set threshold is 0.8 and the calculated value is below the threshold, the adjustment is completed.

In this manner, the transmission policy determination function 22 repeats steps S24 to S26 until the total resource use amount falls within the set threshold. Here, the processing in step S25 may be executed for the transmission policy in which the path generation timing is immediately after data generation, and step S26 may be executed for other transmission policies. Further, step S25 may be further executed for the transmission policy in which step S26 has been executed.

When the total resource use amount falls within the set threshold (Yes in S23), the transmission policy determination function 22 terminates the determination of the set transmission policy. When the determining of the transmission policy in the transmission policy determination function 22 ends, the transmission policy distribution function 23 distributes the transmission policy to each data source 10.

When receiving the transmission policy from the transmission control controller 20, the data source 10 stores the transmission policy in the transmission policy table 19. As a result, as illustrated in FIG. 11, the transmission policy table 19 of each data source 10 stores the transmission policy suitable for the each data source 10.

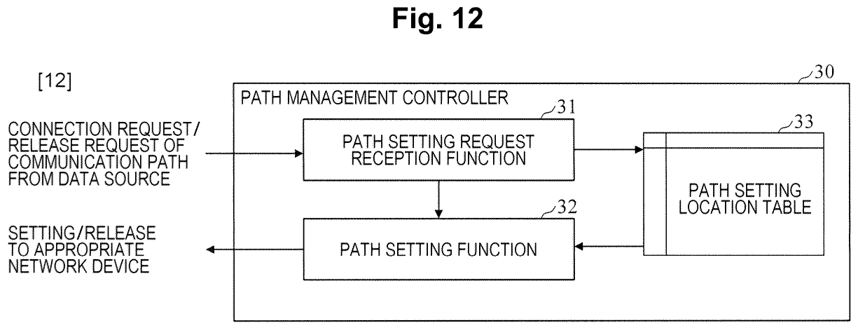

FIG. 12 illustrates a configuration example of the path management controller 30. The path management controller 30 includes a path setting request reception function 31, a path setting function 32, and a path setting location table 33.

The path setting request reception function 31 receives the connection request or the release request of the communication path from each data source 10.

The path setting function 32 generates or releases the communication path in accordance with the connection request or the release request of the communication path from each data source 10.

The path setting location table 33 manages setting information (generation/release) of the communication path from each data source 10 to the server 40.

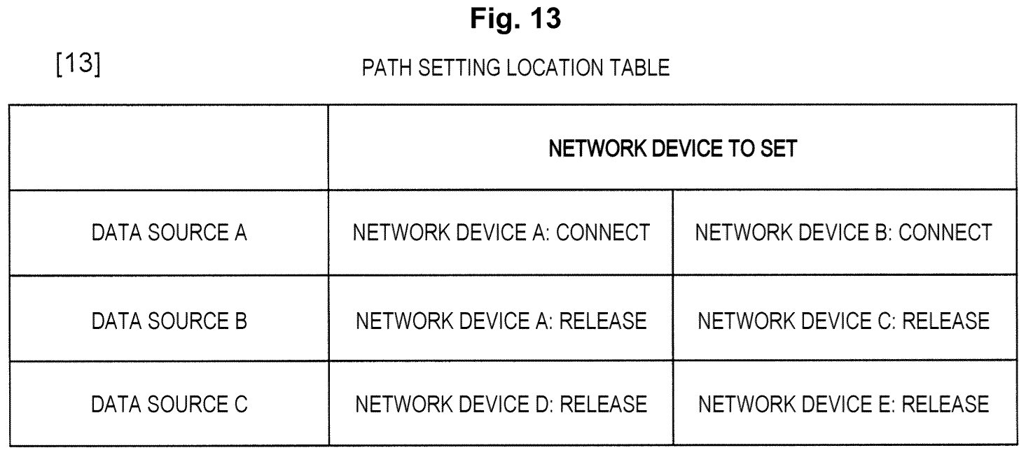

FIG. 13 illustrates an example of the path setting location table 33. The path setting location table 33 stores information of the network devices 81 for transferring sensing data from each data source 10. For example, in the case of the data source 10A, the information of the network devices 81 includes identification information of the network devices 81A and 81B connecting the data source 10A and the server 40, and setting information (generation/release) of the communication paths in the network devices 81A and 81B.

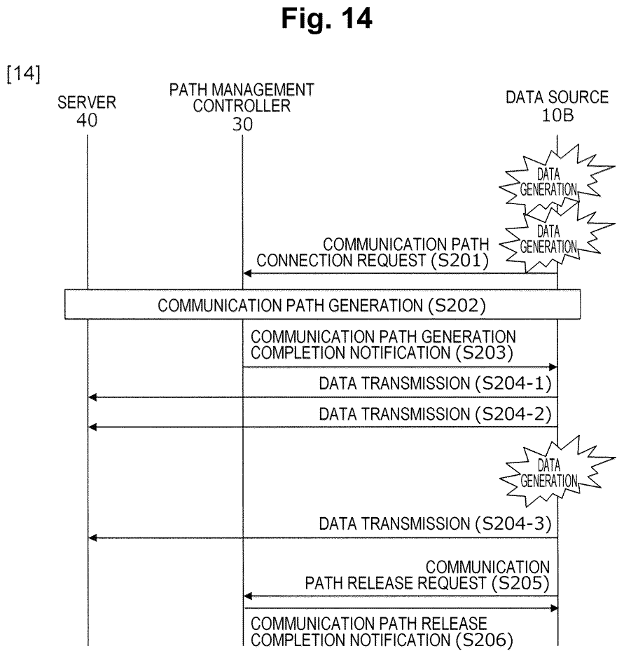

FIG. 14 illustrates an example of transmission of sensing data from the data source 10B to the server 40. The data source 10B transmits the sensing data according to the fourth transmission policy.

The data source 10B accumulates the sensing data generated in the sensor 50, and transmits the connection request of the communication path to the path management controller 30 when the data reaches 20 MB (S201).

When receiving the connection request of the communication path, the path management controller 30 sets the communication paths of the network devices 81A and 81C and generates the communication paths (S202). When the generation of the communication paths is completed, the path management controller 30 transmits a communication path generation completion notification to the data source 10B (S203).

When receiving the communication path generation completion notification, the data source 10B transmits the sensing data to the server 40 (S204-1 and S204-2). Transmission of the release request of the communication path is waited for subsequent 45 ms. When sensing data is generated during that time, the sensing data is transmitted each time generated (S204-3).

When 45 ms elapses from step S204-3, the data source 10B transmits the release request of the communication path to the path management controller 30 (S205).

When receiving the release request of the communication path, the path management controller 30 releases the communication paths of the network devices 81A and 81C, and transmits a communication path release completion notification indicating that the release of the communication paths is completed to the data source 10B (S206).

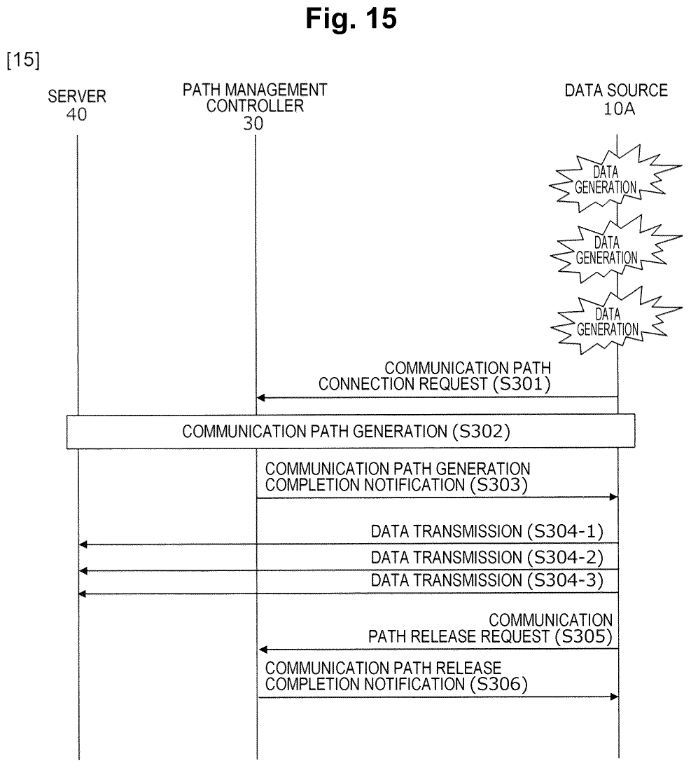

FIG. 15 illustrates an example of transmission of sensing data from the data source 10A to the server 40. The data source 10A transmits the sensing data according to the second transmission policy.

The data source 10A accumulates the sensing data generated in the sensor 50, and transmits the connection request of the communication path to the path management controller 30 when the data reaches 20 MB (S301).

When receiving the connection request of the communication path, the path management controller 30 generates the communication path from the network device 81E to the server 40 (S302). When the generation of the communication path is completed, the path management controller 30 transmits the communication path generation completion notification to the data source 10A (S303).

When receiving the communication path generation completion notification (S303), the data source 10A collectively transmits the accumulated sensing data to the server 40 (S304-1, S304-2, and S304-3). Thereafter, the data source 10A immediately transmits the release request of the communication path to the path management controller 30 (S305).

When receiving the release request of the communication paths, the path management controller 30 releases the communication paths of the network devices 81A and 81B, and transmits the communication path release completion notification indicating that the release of the communication paths is completed to the data source 10A (S306).

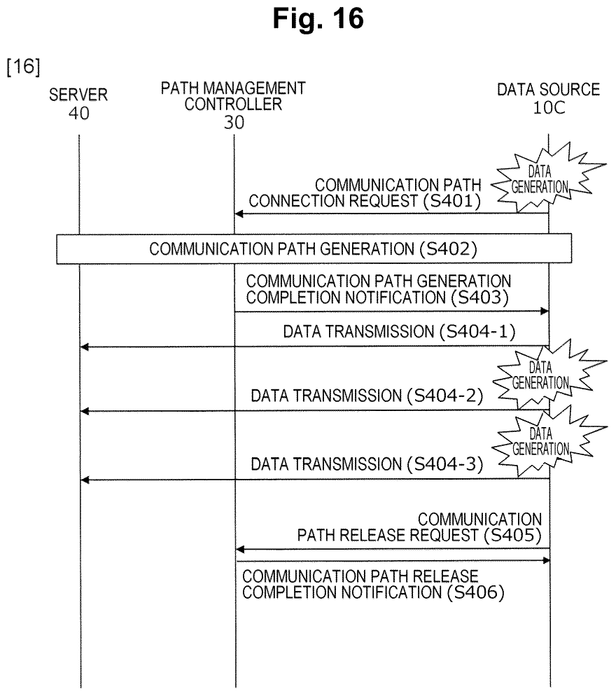

FIG. 16 illustrates an example of transmission of sensing data from the data source 10C to the server 40. The data source 10C transmits the sensing data according to the third transmission policy.

When data is generated in the sensor 50, the data source 10C transmits the connection request of the communication path to the path management controller 30 (S401).

When receiving the communication path generation completion notification (S403), the data source 10C transmits the sensing data to the server 40 (S404-1), and then waits for transmission of the release request of the communication path for a certain period of time. When sensing data is generated during that time, the sensing data is transmitted each time the sensing data is generated (S404-2 and S404-3).

When 20 ms elapses from the last data transmission (step S404-3), the data source 10C transmits the release request of the communication paths to the path management controller 30 (S405).

When receiving the release request of the communication paths, the path management controller 30 releases the communication paths of the network devices 81D and 81E, and transmits the communication path release completion notification indicating that the release of the communication paths is completed to the data source 10C (S406).

As illustrated in FIGS. 14 to 16, in the present embodiment, communication paths are allocated in a time division manner at necessary timings, whereby exhaustion of network resources is prevented, and RDMA communication with a large amount of data sources is implemented. Since the communication paths are allocated only for a necessary period to the data sources 10 from which sensing data is desired to be transmitted, communication path utilization can be improved, and network resources can be reduced.

### Second Embodiment

A system of the present embodiment does not include a path management controller 30 illustrated in FIG. 1. In the present embodiment, a data source 10 directly transmits a connection request of a communication path to network devices 81A to 81E. By reflecting settings of reception by the network devices 81A to 81E, it is possible to omit time and effort until a communication path is generated. As a result, in the present embodiment, the communication path can be set in a shorter time.

In the present embodiment, a communication path setting function 14 transmits a connection request for generating a communication path with a server 40 to the network device 81. In addition, a communication path release function 16 transmits a release request of the communication path with the server 40 to the network device 81.

When sensing data is generated, the data source 10 transmits the connection request of the communication path to the network device 81. The device 81 that has received the request reflects the settings. For example, in a case where a data source 10A transmits the sensing data, the data source 10A transmits the connection request of the communication path to a network device 81B. Then, the network device 81B generates the communication path with the data source 10A.

A connection destination of the communication path of the sensing data is set in advance for each network device 81 set as a transmission route of the sensing data. Thus, in the present disclosure, the preset network devices 81B and 81A connecting the data source 10A and the server 40 generate the communication path between the data source 10A and the server 40. As the communication path, any means capable of transmitting sensing data can be used, and may be a virtual path such as a VLAN or a physical path such as an optical path.

For the connection request of the communication path, data of any format readable by the network device 81 can be used. For example, an Attribute ID region provided in a header of a packet of remote direct memory access (RDMA) can be used.

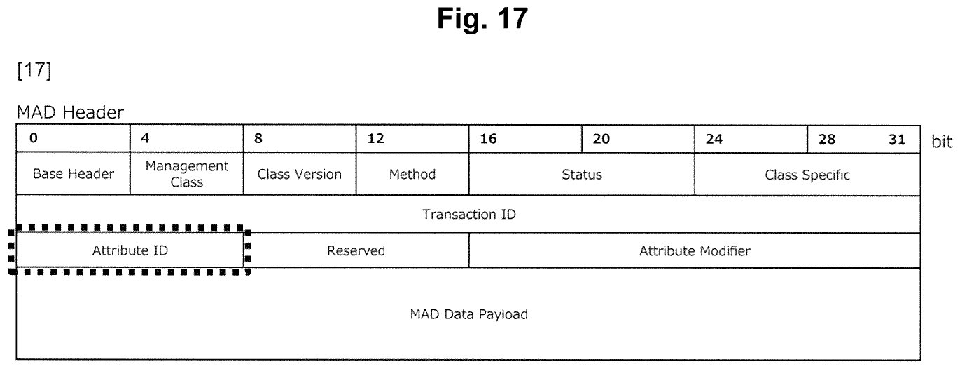

FIG. 17 illustrates an example of the Attribute ID region. In a case of using RDMA over converged Ethernet (ROCE) v2 used in a user datagram protocol (UDP), the network device 81 can identify negotiation on a basis of description of an Attribute ID field in a MAD header. The MAD Header is stored in DATH Header in Base Transport Header.

The negotiation includes, for example, ConnectRequest for making an RDMA connection request, ConnectReply indicating an RDMA connection response, ReadyToUse indicating an available state, DisconnectRequest for making an RDMA release request, and DisconnectReply indicating an RDMA release response. A value of the Attribute ID is set for each negotiation, and for example, when an Attribute ID is 0x0010, the Attribute ID can be used as a trigger for path generation in the network device 81B.

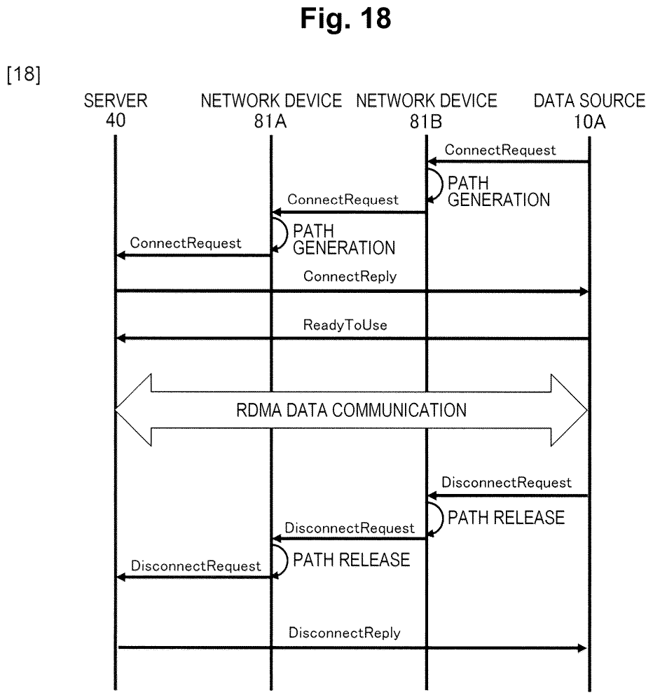

FIG. 18 illustrates an example of a sequence at the time of generating and releasing a communication path. In a case of using RDMA, the data source 10A generates the communication path to the server 40 using ConnectRequest as a trigger. At this time, network device 81B transfers ConnectRequest to the next network device 81A. The network device 81A also transfers ConnectRequest to the server 40 after completion of the generation of the communication path. The server 40 transmits ConnectReply to the data source 10A by using the generated communication path. When receiving ConnectReply from the server 40, the data source 10A transmits ReadyToUse to the server 40. This enables RDMA communication from the data source 10A to the server 40.

Releasing the communication path is similar to the case of generating the communication path. Specifically, the data source 10A releases the communication path to the server 40 using DisconnectRequest as a trigger. At this time, when the release of the communication path is completed, the network device 81B transfers the DisconnectRequest to the network device 81A. The same similarly applies to the network device 81A. When receiving DisconnectRequest, the server 40 transmits DisconnectReply to the data source 10A.

In the network devices 81B and 81A, the timing to transfer ConnectRequest is, for example, after completion of the generation of the communication path. However, the present disclosure is not limited thereto. For example, the network devices 81B and 81A may transfer ConnectRequest without waiting for the completion of the generation of the communication path.

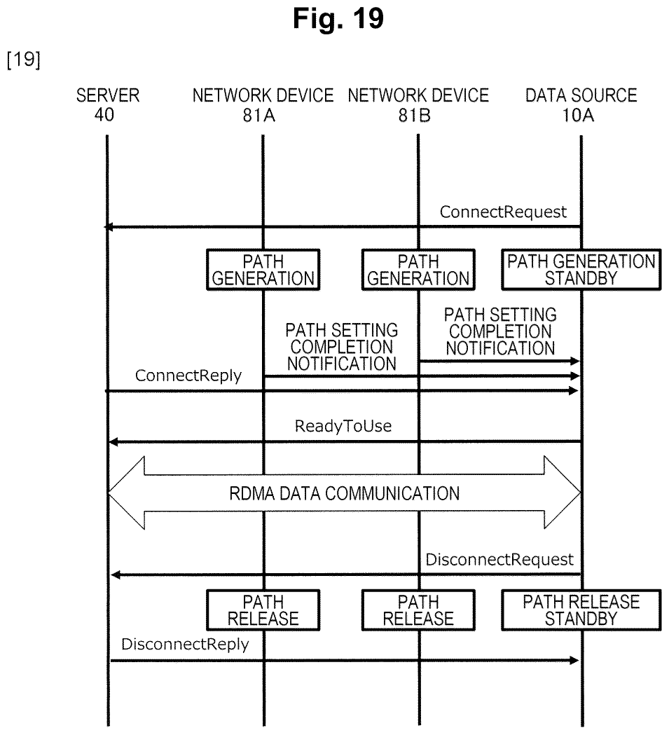

FIG. 19 illustrates an example of a sequence at the time of generating and releasing a communication path. In this example, the network devices 81B and 81A transfer ConnectRequest without waiting for completion of generation of the communication path. In this case, the network devices 81B and 81A have a function to transmit a path setting completion notification to the data source 10A that is a transmission source of ConnectRequest. In the present disclosure, since a transmission route of the sensing data is preset, the data source 10A can confirm that the settings of the communication paths are completed in all the network devices 81B and 81A on the transmission route by counting the number of path setting completion notifications transmitted from the network devices 81B and 81A. When this confirmation can be made, the data source 10A transmits ReadyToUse to the server 40. This enables RDMA communication from the data source 10A to the server 40.

When releasing the communication path, the data source 10A transmits DisconnectRequest to the server 40. The server 40 releases the communication path and transmits DisconnectReply to the data source 10A. Since the communication path is released in the server 40, the communication path is also released in the network devices 81A and 81B.

The present embodiment can implement the lossless and broadband communication network 80 with the communication paths, and enable RDMA communication with a large number of data sources without requiring a large amount of network resources. Furthermore, the present disclosure can prevent data loss in the communication network 80, and thus can implement reliable data transfer using RDMA.

### Effects of Present Disclosure

As described above, the present disclosure determines the transmission policy for each data source 10 and generates the communication path for each data source 10 in accordance with the transmission policy, and thus can allocate the communication paths in a time-division manner at necessary timing. Therefore, the present disclosure can perform control to reduce the communication path use time from each data source 10 to the server 40, facilitate reuse of the communication paths, and reduce the required number of communication paths for the entire communication network 80 with respect to the trade-off between immediacy of data transmission and reduction in communication path use time.

Here, in the present disclosure, a transmission control controller 20 determines a transmission policy in consideration of entire NW resources. Therefore, in the present disclosure, it is possible to reduce a total resource use amount as a whole by causing communication to stand by from one with a loose requirement such as only collecting data. Furthermore, the present disclosure can prevent exhaustion of network resources by determining a set threshold of the total resource use amount in consideration of a network resource remaining amount.

Therefore, the present disclosure can implement the lossless and broadband communication network 80 with the communication paths, and enable RDMA communication with a large number of data sources without requiring a large amount of network resources. Furthermore, the present disclosure can prevent data loss in the communication network 80, and thus can implement reliable data transfer using RDMA.

Note that, in the present embodiment, an example in which data collected by the server 40 is sensing data has been described. However, the present disclosure is applicable to any data required to be collected, such as data in user terminals, sensors, or in-vehicle systems.

Furthermore, in the above-described embodiments, an example of setting the lossless and broadband communication path between the data source 10 and the server 40 has been described. However, a transfer route of data of which quality is not guaranteed may be set as the communication path.

### INDUSTRIAL APPLICABILITY

The present disclosure can be applied to the information communication industry.

### REFERENCE SIGNS LIST

10, 10A, 10B, 10C Data source
20 Transmission control controller
30 Path management controller
40 Server
50 Sensor
11 Requirement notification function
12 Transmission policy reception function
13 Data transmission timing control function
14 Communication path setting function
15 Data transmission function
16 Communication path release function
17 Generated data storage function
18 Requirement table
19 Transmission policy table
21 Requirement reception function
22 Transmission policy determination function
23 Transmission policy distribution function
24 Transmission policy determination rule
31 Path setting request reception function
32 Path setting function
33 Path setting location table
41 Data reception function
42 Memory
43 Application
80 Communication network
81A, 81B, 81C, 81D, 81E Network device

1. A system for collecting data from a plurality of data sources to a server, the system comprising:
a controller that determines a transmission policy to be distributed to the plurality of data sources, wherein
the controller
determines the transmission policy of each data source on a basis of a data transfer requirement from the plurality of data sources to the server,
calculates a total resource use amount of a case where the plurality of data sources executes the transmission policies set for the respective data sources, and
adjusts the transmission policy of each data source so that the total resource use amount falls within a set threshold.

2. The system according to claim 1, wherein
the transmission policy includes timing of releasing a communication path, and
the controller advances the timing of releasing a communication path in any one of the plurality of data sources to reduce a resource use amount of the data source.

3. The system according to claim 1, wherein
the transmission policy includes timing of generating a communication path, and
the controller delays the timing of generating a communication path in any one of the plurality of data sources to reduce a resource use amount of the data source.

4. The system according to claim 3, wherein
the data transfer requirement includes an allowable delay time, and
the controller delays the timing of generating a communication path in the data source having the allowable delay time that is long among the plurality of data sources.

5. The system according to claim 4, wherein
the transmission policy includes timing of releasing a communication path, and
the controller delays the timing of generating a communication path in a case where a path release standby time in the data source having the allowable delay time that is long among the plurality of data sources is 0.

6. A method executed by a system for collecting data from a plurality of data sources to a server,
the system including a controller that determines a transmission policy to be distributed to the plurality of data sources, the method comprising:
by the controller,
determining the transmission policy of each data source on a basis of a data transfer requirement from the plurality of data sources to the server;
calculating a total resource use amount of a case where the plurality of data sources executes the transmission policies set for the respective data sources; and
adjusting the transmission policy of each data source so that the total resource use amount falls within a set threshold.

7. A non-transitory computer-readable medium having computer-executable instructions that, upon execution of the instructions by a processor of a computer, cause the computer to function as the controller included in the system according to claim 1.
